(19) United States
(12) Patent Application Publication
(10) Pub. No.: US 2013/0335027 A1
(43) Pub. Date: Dec. 19, 2013

(54) Secure Mobile Electronic Device Servicing Kiosk

(71) Applicant: Jiang Xin, Kew Gardens, NY (US)

(72) Inventor: Jiang Xin, Kew Gardens, NY (US)

(21) Appl. No.: 13/523,780

(22) Filed: Jun. 14, 2012

(51) Int. Cl. H02J 7/00

(52) U.S. Cl. 320/114

(57) ABSTRACT

A compact mobile electronic device servicing kiosk which provides speed charging and UV sterilization services to at least one mobile electronic device locked in at least one compartment. To achieve key-less access to the compartments, an interactive computing interface keeps temporary records of authentication characteristics collected from authentication means such as a biometric device or a payment device for compartment access authorization. The interactive computing interface also serves as multimedia content display and user interaction device. The interactive computing interface is wireless accessible to local area network or to the Internet which enables download and upload content from and to various external sources as well as enabling remote control for operation and maintenance purposes. Given the security and mobility features, the kiosk fits perfectly in any public locations where users can conveniently obtain a quick service without having to wait in front of the kiosk during the service session.

### BACKGROUND OF THE INVENTION

It is an undisputable fact that modern human lives are heavily dependent upon the use of mobile electronic devices such as cellphones, smartphones, tablets, portable gaming systems, digital cameras, camcorders etc. as part of their daily routine. Given the mobility of these devices, they are primarily battery powered. Due to the drastically increase of functionality, features and the frequent use of these mobile electronic devices, it becomes a common challenge that the battery capacity cannot keep up with increasing demands. As a result, we often find ourselves in situations where we cannot use these mobile electronic devices when we need them in the public because they are out of charge.

There is another issue which is being realized by the general public, device hygiene. As people are using them more frequently or even at all times, these devices quickly become a main carrier of bacteria. Some study indicates that cell phones have 18 times more bacteria than a toilet handle. It poses a serious health challenge waiting for a resolution.

Additionally, in our busy modern life, multi-tasking is a key to better leverage our precious time. Regardless how fast a charger can speed charge a mobile electronic device, it still require at least 10 minutes to make the charging worthwhile. Typically, people will expect to have at least 10 minutes of their lives wasted while waiting and guarding their device being recharged in the public. Although some of the preexisting kiosks have features of locking the devices in the kiosk during the charging session, but the authentication schemes are primarily based on either key code or physical key which present a well-perceived drawback, they can be easily forgotten, misplaced and stolen.

### DESCRIPTION OF THE PRIOR ART

Nowadays, mobile electronic device charging kiosks are seen in airport, bus terminals, or other public places where device users can leverage such a service to charge their device. There a numerous prior-art references specified in the following publications: US. Pat. No. 2010/0259213 A1, U.S. Pat. No. 2011/0145073 A1, US. Pat. No. 5,544,784 and U.S. Pat. No. 5,744,933. Each of these prior-art references shows a kiosk capable of charging cell phones. Some of them show that they have one or multiple screens for multimedia displays and/or user interactions. However, they all fail to show the compact design which will fit in practically any public location and they all fail to show more enhanced features which are required to address a variety of issues pertaining to publically servicing diverse types of mobile electronic devices.

Despite of multi-functional mobile electronic device charging kiosk are known in the art, the present invention of mobile electronic device servicing kiosk possess much more improved functions which were not previously available from other inventions.

### SUMMARY OF THE INVENTION

The mobile electronic device servicing kiosk comprises: a compact enclosure which equipped with multiple electromechanically lockable compartments where mobile electronic devices of different sizes and types can be accommodated simultaneously. At least one universal charging interface or at least one inductive charging unit and at least one UV sterilizing unit located inside of each of aforementioned compartments. An interactive computing interface integrated on the enclosure. A biometric device for user authentication without the needs of remembering a pass code or using a key. At least one intelligent power unit which are controlled by the combination of the interactive computing interface and a circuit control board for all power needs pertaining to speed-charging, UV sterilization, compartment locking and unlocking and other services. At least one cooling fan inside the enclosure for enclosure's heat dissipation.

The interactive computing interface serves the following purposes: it serves as a touch screen which is used for user to interact with the service kiosk. It serves as a display which plays live or pre-recorded multimedia contents such as advertisement, news, trivial statistics or even TV programs. It is equipped with Wi-Fi, Bluetooth, cellular network and USB modules which can serve as a connectivity gateway enabling online access to either the Internet or local area network for the kiosk itself or even serving as a wireless access point for external wireless online capable devices. It is equipped with a camera capable of capturing still or moving pictures. It contains a local database which can support kiosk's operation logics as well as synchronize data with central database located on the Internet for backup and analytical purposes. It contains a local storage module which can store data such as aforementioned multimedia advertisement, database, biometric characteristics etc.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a perspective view of the front of one embodiment of a servicing kiosk in accordance with the present invention;

FIG. 2 is a rear view of the embodiment of FIG. 1 being vertically cut open revealing main components resided within;

FIG. 3 is a functional block diagram of a kiosk in accordance with the present invention;

FIG. 4 is a flow chart illustrating a method of operating a service kiosk using a control system wherein the services are provided based upon user biometric identification.

### DETAILED DESCRIPTION OF THE DRAWINGS

In preferred embodiment of the invention, a method and apparatus for a public mobile electronic device servicing kiosk with an integrated interactive computing interface, a plurality of servicing compartments, and an authentication means are provided.

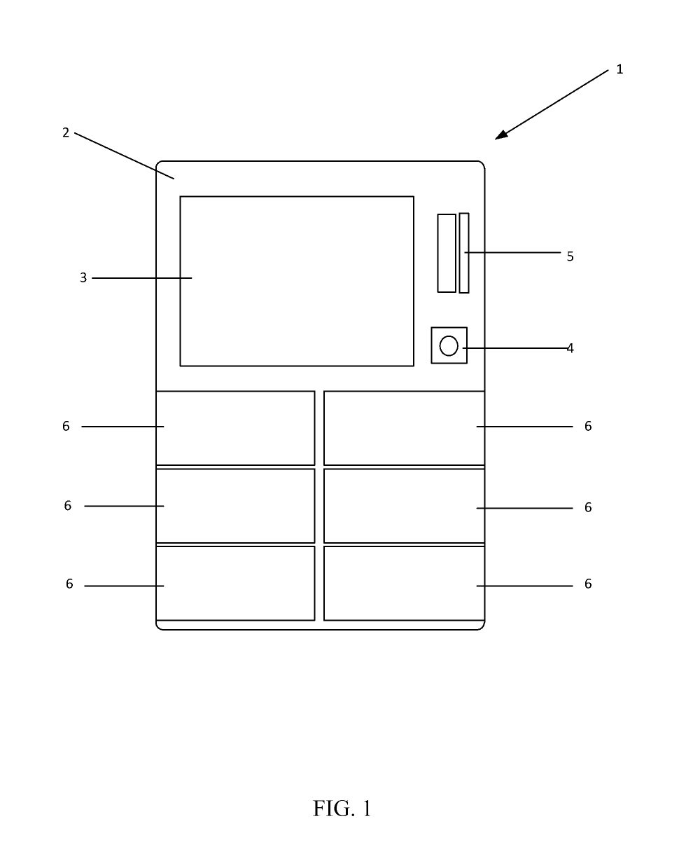

With reference to FIG. 1, there is a front perspective view of the servicing kiosk 1 of the preferred embodiment of the present invention. The servicing kiosk 1 can include a compact enclosure 2, an interactive computing interface 3, a biometric authentication means 4, an electronic payment means 5 and a plurality of servicing compartment doors 6.

The enclosure 2 can be used to house the components of the servicing kiosk 1. The compact enclosure can be of wall hanging, free standing on a stand and table top types to conserve space required in public locations.

The interactive computing interface 3 can be provided on upper section of the enclosure 2 where it is on users' eye level for easy viewing and operating purposes.

A plurality of servicing compartments doors 6 can be positioned on the lower section of the enclosure 2 where it is easy for users to access for services. The compartment doors horizontally swing open from the outer edges of the enclosure 2 which provides easy simultaneous user access. The compartment doors can be made of reinforced material to prevent theft or vandalism.

As shown herein, the authentication means 4 is a biometric fingerprint reader which scans users' fingerprint. After the scan, the fingerprints are transformed into digital value to be stored and compared in the database of the interactive computing interface 3 for access authentication to the servicing compartments. The authentication means can also be other types of biometric device such as iris scanner or facial recognition device etc. which take users' unique characteristics for authentication purposes without needing users to remember a passcode or use a key.

In one aspect, the servicing kiosk can include an electronic payment means 5 if the owner of the kiosk decided to charge user for the services provided. The electronic payment means can be a payment card reader, a NFC (Near Field Communication) based payment device for convenient yet secure payment transactions.

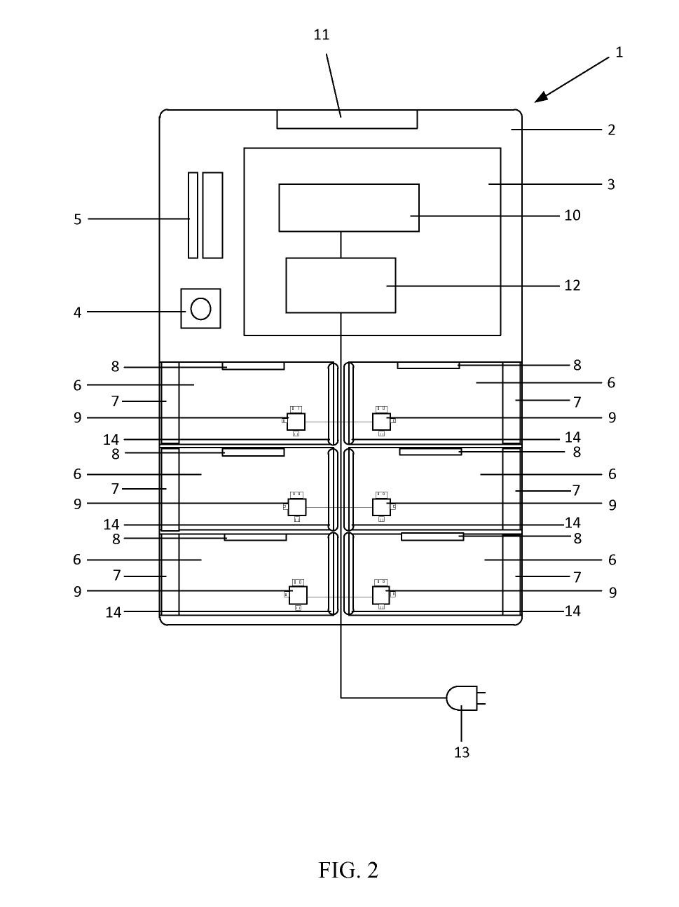

Referring to FIG. 2, the rear vertical cut open view of the preferred embodiment of the servicing kiosk 1 is shown. Inside the enclosure 2, the following interconnected components of the present invention are shown: the interactive computing interface 3, the biometric authentication means 4, the electronic payment means 5, the servicing compartment door 6, the electromechanical lock 7, the ultra violet sterilization means 8, the universal charging interface 9, the power supply unit 10, the cooling means 11, the central control circuit board 12, the local power input 13 and the hidden door hinges 14.

The servicing compartment is secured by the combination of the compartment door 6, the electromechanical locking means 7 and the hidden door hinges 14. The hidden door hinges 14 are mounted inside the compartment doors to avoid destruction from the outside. It also has a slight yetconsistent pulling force to pull the compartment door 6 into closed position. The electromechanical locking means 7 is controlled by the central control circuit board 12 based on authentication results provided by the biometric authentication means 4.

There is a universal charging interface 9 residing inside of each servicing compartment. In the preferred embodiment, the universal charging interface can include interfaces for all major mobile electronic devices such as Apple, Mini USB and Micro USB connecters etc. on one single cable. The universal charging interface 9 can also be a type of inductive charging interface which leverage electromagnetic field for wireless energy transfer between the charging interface and mobile electronic device.

As shown on FIG. 2, there is a UV sterilization means 8 in each servicing compartment. It can be a low wattage ultra violet LED which emits short ultra violet wave length between 240 nm and 280 nm to effectively achieve bacteria sterilization for the mobile electronic device being serviced in the servicing compartment. It is contemplated within the scope of the present invention that a singular or a plurality of the UV sterilization means can be mounted on any inner sides of the servicing compartment for the most efficient and effective UV sterilization results.

There is a power supply unit 10 located inside the enclosure 2 behind the interactive computing interface 3. The power supply unit rectifies and transforms 110 volt-220 volt AC power input from the local power input 13 to a lower voltage DC power output which feeds into the central control circuit board 12. In addition, the power supply unit 10 also has safety features such as over-voltage and short-circuit protections to prevent from damaging the central control circuit board 12.

The central control circuit board 12 will further transforms and distributes various low voltage DC currents to components such as the interactive computing interface 3, the biometric authentication means 4, the electronic payment means 5, the electromechanical locking means 7, the UV sterilization means 8, the universal charging means 9 and the cooling means 11 etc.

It is also illustrated in FIG. 2, there is a cooling means located on the top of the enclosure 2. It can be a cooling fan which designed to increase air circulation inside the enclosure 2 by drawing hot air out to ensure proper operating temperature is maintained. It is also contemplated within the scope of the present invention that a singular or a plurality of the cooling means can be placed anywhere inside or outside of the enclosure to fulfill the heat dissipation requirements.

Lastly, on FIG. 2, there is a local power input which can be plugged into a wall outlet near the servicing kiosk 1 to supply AC power to the power supply unit 12. However, it is also contemplated within the scope of the present invention that instead of the local power input, alternative power sources can be provided to the kiosk 1 such as solar power generation unit.

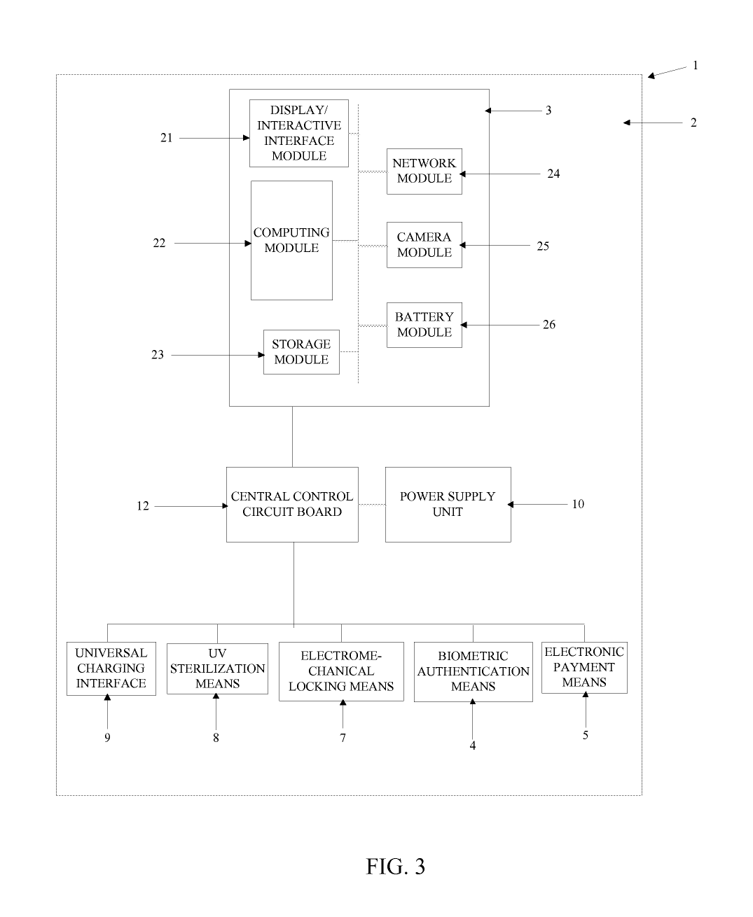

With reference to FIG. 3, it is a functional block diagram illustrating the main components of the servicing kiosk 1. There are three main sections within the enclosure 2: the upper section is the interactive computing interface 3, the middle section has the central control circuit board 12 and the power supply unit 10. The lower section is consist of the charging means 9, the UV sterilization means 8, the electromechanical locking means 7, the biometric authentication means 4 and the payment means 5.

The interactive computing interface 3 in the upper section is the brain of the whole servicing kiosk. It is equipped with a display/interactive interface module 21 which serves as both the display for multimedia contents and the touch screen for user-kiosk interaction.

The computing module fulfills the computing needs of kiosk 1 as it conducts logical and mathematical computation required by various kiosk services such as making decisions and executing instructions based on predefined service workflow, encoding and decoding multimedia contents or controlling other functional modules and corresponding services within the interactive computing interface 3 etc.

The storage module 23 stores the underlining operating system such as Android, Apple IOS or Windows Mobile 8 etc. which controls the hardware functions of the interactive computing interface 3. It also houses, on top of the operation system, the application layer which controls the servicing kiosk functions. The application layer can be written in various programming languages such as Java, Objective C or Visual Basic etc. The storage module also contains local databases which keeps records of servicing compartment locking status as well as user biometric authentication records to ensure a secured environment for the mobile electronic devices being serviced in the servicing kiosk 1. In addition, the storage module 23 serves as a local repository for multimedia contents which are displayed or played on the display/interactive interface module 21. It can also restore other needed contents temporarily or long-term depends on the needs.

The network module 24 can function as wired (Ethernet) or wireless (Wi-Fi or cellular network) adapter which can provide online connectivity to the servicing kiosk 1 to local area network where the kiosk 1 is located or to the Internet for data communications with broader peers. In addition, it can also be a Wi-Fi or Bluetooth access point which will provide online access for mobile electronic device users who are in the proximity of the kiosk 1.

The camera module 25 can capture still or motion pictures which can be used for biometric authentication such as iris scanning or facial recognition for access to service compartments. It can also be used for surveillance purposes to capture images of vandalism or theft against the kiosk 1. The images can either be stored locally or be sent to the central control servers for police investigation. It can also be used for gesture control based user interaction with the kiosk 1. For instance, instead of using the touch screen, users can interact with the kiosk 1 by having the camera module 25 capture recognizable gestures.

The battery module 26 serves as backup power for the interactive computing interface 3 or even some lower section components in case a local power failure occurs. During the local power failure, the battery module can provide sufficient power for a short period of time to sustain all major functions within the interactive computing interface 3. In doing so, it enables alerts to be sent to the remote central control servers; it triggers the upload of local data i.e. service states or database to the central control server for backup purposes and it can even allow messages to be displayed on the display informing users to end the services and pick up their mobile electronic devices while providing ample power to unlock the electromechanical locking means 7. In the middle section, the power supply unit 10 interconnects local AC power and the central control circuit board 12. It serves as a combination of a rectifier and a transformer to convert AC power to DC power and to transform from higher voltage to lower voltage before supplying the power to the central control circuit board.

The central control circuit board 12 can serve as a hub which interconnects the interactive computing interface 3, the power supply unit 10 and all components within the lower section of the kiosk 1. More importantly, it can also transform from digital instructions issued by the interactive computing interface 3 to analogue signal for the lower section components to execute and vice versa. For instance, when interactive computing interface 3 issues a command to lock the servicing compartment door 6, the digital command is passed on to the central control circuit board 12 and then transformed into pre-defined voltage which represents locking command. The voltage is then sent to the electromechanical locking means 7 for locking command execution.

In addition, the central control circuit board can also consist of various chipsets which intelligently controls the speed charging service. When a user connects his/her mobile electronic device to the universal charging interface 9, the chipset will attempt to detect the voltage coming from the battery of the device to determine how to set the initial charging voltage. If it is below the minimum voltage of most of the common battery specifications, it will conduct “trickle charge” by applying small current to the battery to avoid damage. Once the chipset detects that the battery voltage increases beyond the minimum voltage, it will then apply higher but steady current to achieve “speed charge” effect. After the chipset detects that the battery voltage reached a predefined level, it will then gradually decrease the current while maintaining steady voltage to achieve “deep charge” of the battery. in the end, when the current reaches a predetermined low level, the chipset will send end of charge command to cut power input to the universal charging interface 9 to complete the service.

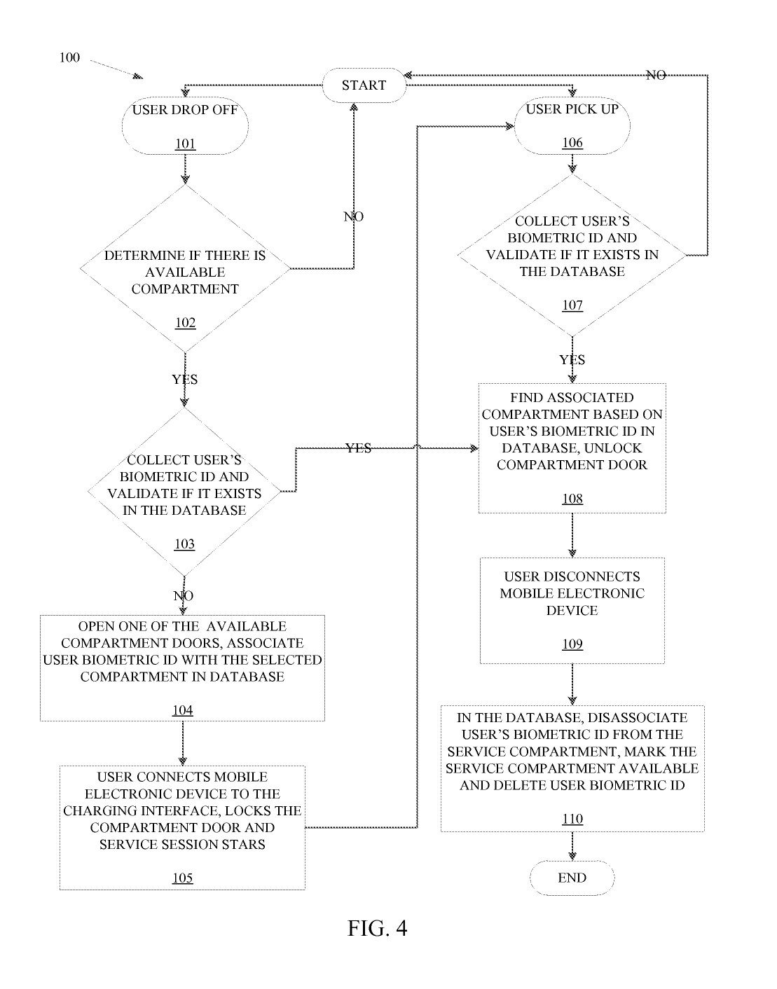

FIG. 4 illustrates a flow chart representing a method 100 of operating a service kiosk using a interactive control system such as the interactive computing interface shown on FIGS. 1, 2 and 3 wherein the services are provided based upon user biometric identification. The apparatus which would be used in the conduct of method 100 could be a wall-hanging or free-standing kiosk such as servicing kiosk 1 shown in FIGS. 1, 2 and 3.

A user selects user drop off 101 option on the interactive computing interface, the interactive computing interface will search its internal database to determine if there is available compartment 102. If there is no available for service at the moment, it will go back to the default start of the method 100 after displaying a message on the interactive computing interface 3 indicating there is no vacancy at the moment and please try later. If there is available compartment for service then it will proceed to the next step 103 to collect user's biometric ID and validate if it exists in the database.

The user is prompted to provide his/her biometric ID such as fingerprint or iris scan profile. Upon completion of collecting user's biometric ID, the interactive computing interface will search its internal database to validate if it previously exists in the database 103. If it previously exists, that means the user's mobile electronic device is currently locked in one of the compartments, it will go to step 108 to findassociated compartment in the database. If the collected biometric ID does not exist in the database, it will then move to step 104.

At step 104, the interactive computing interface 3 selects one of the available compartments and opens the corresponding compartment door. Meanwhile, it also associates the collected user biometric ID with the selected compartment in the database for validation in later retrieval process.

At step 105, user connects mobile electronic device to the universal charging interface 9, upon closing the compartment door 6, the electromechanical locking means 7 automatically locks the compartment door. The interactive computing interface will then activate both charging and UV sterilization services in the compartment and starts the countdown of predetermined service duration, i.e. 10 minute service session.

When the service duration countdown ends or the user demands to retrieve the mobile electronic device during the service duration, s/he may select user pick up 106 option on the interactive computing interface 3.

The user is then prompted to provide his/her biometric ID for validation. Upon validation in the database, if the collected biometric ID does not exist in the database, that means the user does not have his/her mobile electronic device locked in one of the compartments for service. It will then go to the start of the method 100. If the biometric ID exists in the database, it will then go to the next step 108.

At step 108, based on the collected biometric ID, the interactive computing interface will find and open the door of associated compartment in the database.

Once user disconnects and retrieves his/her mobile electronic device at step 109, step 110 takes place within the interactive computing interface database which are the actions of disassociating user's biometric ID from the service compartment, marking the service compartment available and deleting user's biometric ID. Thereafter, method 100 ends.

The foregoing is considered as illustrative only of the principles of the invention. Further, since certain changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A servicing kiosk for servicing mobile electronic device, the servicing kiosk comprising:
A compact enclosure;
An interactive computing interface operative to control kiosk service functions, to display multimedia contents, to interact with users and to provide data exchange connectivity;
At least one lockable servicing compartment wherein at least one ultra violet light emitting unit for UV sterilization, one universal charging interface for charging mobile electronic device of different types, and one electromechanically controlled locking means for locking and unlocking of the compartment, are resided;
At least one biometric authentication means authenticating user for obtaining the services by locking their devices in the compartment or for retrieving devices from the locked compartment after the services are complete;
At least one intelligent electrical power control module operatively connect and supply power to the at least one universal charging interface, to the at least one ultra violet light emitting unit and to the at least one electromechanical locking device;
At least one cooling means for heat dissipation.

2. The servicing kiosk of claim 1 wherein more than one servicing compartment is provided.

3. The servicing kiosk of claim 2 wherein more than one universal charging interface is provided.

4. The servicing kiosk of claim 2 wherein more than one Ultra violet light emitting unit is provided.

5. The servicing kiosk of claim 2 wherein more than one electromechanically controlled locking means is provided.

6. The servicing kiosk of claim 1 wherein the authentication means comprises at least one of biometric authentication device types: fingerprint reader, iris scanner or facial recognition device.

7. The servicing kiosk of claim 1 wherein an electronic payment means such as a payment card reader or a NFC (Near Field Communication) based device is provided.

8. The servicing kiosk of claim 1 wherein a wireless access point for surrounding wireless online capable devices to be connected to local area network or the Internet is provided.

9. The servicing kiosk of claim 1 wherein the interactive computing interface is an integrated device which comprises of at least one CPU, at least one memory module, at least one storage module, at least one touch screen, at least one connectivity module, at least one battery backup power module, at least one software application.

10. The interactive computing interface of claim 7 wherein the software application controls the kiosk service functions, displays multimedia content and communicates securely with central control server cluster for data exchange and remote support.

11. The servicing kiosk of claim 1 wherein the at least one servicing compartment is locked and unlocked by the at least one electro-mechanically controlled locking means controlled by the interactive computing interface based on authentication results provided by the biometric authentication means.

12. The servicing kiosk of claim 1 wherein the at least one ultra violet light emitting unit is a short wave length ultra violet light emitting unit for bacteria sterilization.

13. The servicing kiosk of claim 1 wherein the at least one intelligent charging module is controlled by the interactive computing interface, is capable of switching among steady voltage charge, trickle charge, steady current charge and no charge modes based on battery status and pre-defined condition logics.

14. The servicing kiosk of claim 1 wherein the at least one universal charging interface is a charging cable which provides all common mobile electronic device charging connector types or is a inductive charging interface for wireless charging.

15. A method comprising:
Providing a servicing kiosk for simultaneously charging and UV sterilizing mobile electronic devices in locked servicing compartment which requires a form of authentication for access.
